(19) United States
(12) Patent Application Publication
(10) Pub. No.: US 2013/0205090 A1
(43) Pub. Date: Aug. 8, 2013

(54) MULTI-CORE PROCESSOR HAVING HIERARCHICAL COMMUNICATION ARCHITECTURE

(71) Applicant: Electronics and Telecommunications Research Institute, Daejeon (KR)

(72) Inventor: Jae-Jin Lee, Daejeon (KR)

(73) Assignee: Electronics and Telecommunications Research Institute, Daejeon (KR)

(21) Appl. No.: 13/757,216

(22) Filed: Feb. 1, 2013

(30) Foreign Application Priority Data
Feb. 6, 2012 (KR) 10-2012-0012035

(51) Int. Cl. G06F 12/08

(52) U.S. Cl. CPC G06F 12/0811
USPC 711/122

(57) ABSTRACT

Disclosed is a mufti-core processor having hierarchical communication architecture. The multi-core processor having hierarchical communication architecture is configured to include clusters in which cores are clustered; a lowest level memory shared among the cores included in the clusters; a middle level memory shared among the clusters; and a highest level memory shared by all the clusters. In accordance with an exemplary embodiment of the present invention, it is possible to improve the performance of the applications by reducing the communication overhead between respective core and supporting the data and functional parallelization.

### CROSS-REFERENCES TO RELATED APPLICATIONS

The present application claims priority under 35 U.S.C 119(a) to Korean Application No. 10-2012-0012035, filed on Feb. 6, 2012, in the Korean Intellectual Property Office, which is incorporated herein by reference in its entirety set forth in full.

### BACKGROUND

Exemplary embodiments of the present invention relate to a multi-core processor, and more particularly, a mufti-core processor having hierarchical communication architecture using a memory that can be shared among each core and can be hierarchically divided.

Currently, a processor used for smart phones, and the like, has been developed from a single core to a dual core. With the development and miniaturization of the processor, the processor is expected to be developed to a multi core over a quad core. In addition, in a next-generation mobile terminal such as a tablet PC, and the like, it is expected that biometrics and augmented reality can be implemented by using a mufti-core processor in which several tens to several hundreds processors are integrated.

A method of increasing a clock speed so as to improve performance of a process during this process has been used until now. However, the clock speed is increased and power consumption and heating is increased accordingly. Therefore, the increase in the clock speed reach the limit and thus, it is difficult to increase the clock speed. The multi-core processor proposed as an alternative is mounted with several cores and as a result, an individual core can be operated at lower frequency and power consumed by a single core can be distributed to an individual core.

The mufti-core processor corresponds to one including at least two central processing units and therefore, can perform an operation at higher speed than a single core processor at the time of performing an operation with programs supporting the mufti-core processors. In addition, in the next-generation mobile terminal that basically performs multimedia data processing, the mufti-core processor has higher performance than the single core processor, in operations such as compression and reconstruction of moving pictures, high-specification games, augmented reality, and the like.

An example of the most important factors in the mufti-core processor may include a support of data level and functional parallelization, efficient communication architecture capable of reducing communication overhead among cores.

To this end, in the related art, a method for increasing performance and reducing memory communication overhead while sharing data among the cores as maximally as possible by using high-performance and high-capacity data cache has been proposed. The method is efficient when many cores share the same information like moving picture decoding applications, but is inefficient when each core uses different information.

In addition, a method for efficiently performing parallel processing in mufti-core processor environment by controlling the number of processors assigned to an information consumption processor or an information assignment unit and appropriately limiting an access to a job queue based on a state of a sharing queue (memory) storing information by an information generation processor generating information and the information consumption processor consuming the generated information has been proposed. However, the method may require an additional function module for monitoring a sharing memory and controlling a core and degrade performance due to an access restriction to the sharing memory.

In addition to this, a method for reducing communication overhead by compressing and transmitting data at the time of transmitting data among a plurality of graphic processors has been proposed. The method can reduce the communication overhead through the data compression but may require the additional processing for compression and reconstruction and therefore, cause degradation in performance.

Further, a method of using multicast packets for inter-multiprocessor communication has been proposed. The method may be efficient in communication among processors located at any points, but may be ineffective in dedicated communication among specific processors.

As the related art, KR Patent Laid-Open No. 2011-0033716 (Publication in Mar. 31, 2011: Apparatus and method for managing memory)

The above-mentioned technical configuration is a background art for helping understanding of the present invention and does not mean related arts well known in a technical field to which the present invention pertains.

### SUMMARY

An embodiment of the present invention is directed to a multi-core processor having hierarchical communication architecture capable of improving performance of applications by reducing inter-core communication overhead in mufti-core processor environment and supporting data level and functional parallelization.

Further, an embodiment of the present invention is directed to a mufti-core processor having hierarchical communication structure capable of implementing efficient communication among specific processors while having extendibility and generality without degrading performance.

An embodiment of the present invention relates to a mufti-core processor, including: clusters in which cores are clustered; a lowest level memory shared among the cores included in the clusters; a middle level memory shared among the clusters; and a highest level memory shared by all the clusters.

The middle level memory may include: a middle and low level memory which is shared by the cluster and its other neighboring clusters; and a middle and high level memory shared in a super cluster in which the clusters are clustered.

The lowest level memory may be used to implement a parallelization method by functional division of applications.

The lowest level memory may perform a single or double buffer function transmitting data processed by the cores to neighboring cores.

The middle level memory may be used to implement a parallelization method by data division of applications.

The highest level memory may be used to store data shared for the cores to perform applications.

A memory access may be performed in an order of the lowest level memory, the middle level memory, and the highest level memory at the time of performing communication among the cores.

The memory access may be performed through a memory bus or a direct memory access (DMA).

### BRIEF DESCRIPTION OF THE DRAWINGS

The above and other aspects, features and other advantages will be more clearly understood from the following detailed description taken in conjunction with the accompanying drawings, in which:

FIG. 1 is a diagram for describing a parallelization method by data division;

FIG. 2 is a diagram for describing a parallelization method by functional division;

FIG. 3 is a diagram illustrating an example of a functional parallelization method for moving picture decoding;

FIG. 4 is a diagram illustrating hierarchical communication architecture within any one cluster among multi-core processors having hierarchical communication architecture in accordance with an embodiment of the present invention;

FIG. 5 is a multi-core processor having hierarchical communication architecture in accordance with an embodiment of the present invention; and

FIG. 6 is a diagram for describing a parallelization method of data level of multimedia moving picture decoding using an L2 memory of a mufti-core processor having hierarchical communication architecture in accordance with an embodiment of the present invention.

### DESCRIPTION OF SPECIFIC EMBODIMENTS

Hereinafter, a multi-core processor having hierarchical communication architecture in accordance with an embodiment of the present invention will be described with reference to the accompanying drawings. During the process, a thickness of lines, a size of components, or the like, illustrated in the drawings may be exaggeratedly illustrated for clearness and convenience of explanation. Further, the following terminologies are defined in consideration of the functions in the present invention and may be construed in different ways by intention or practice of users and operators. Therefore, the definitions of terms used in the present description should be construed based on the contents throughout the specification.

A mufti-core processor having hierarchical communication structure in accordance with an embodiment of the present invention hierarchically divides and uses a memory that can be shared among respective cores, thereby realizing data level and functional parallelization of applications and minimizing communication overhead.

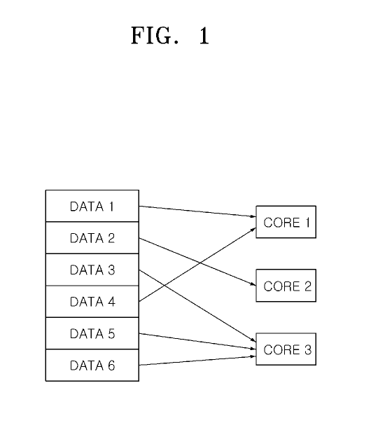

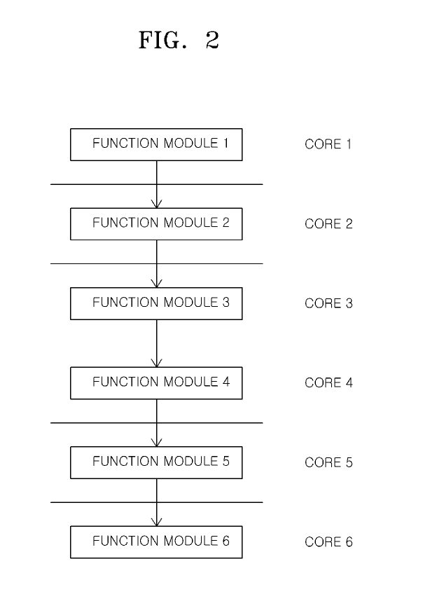

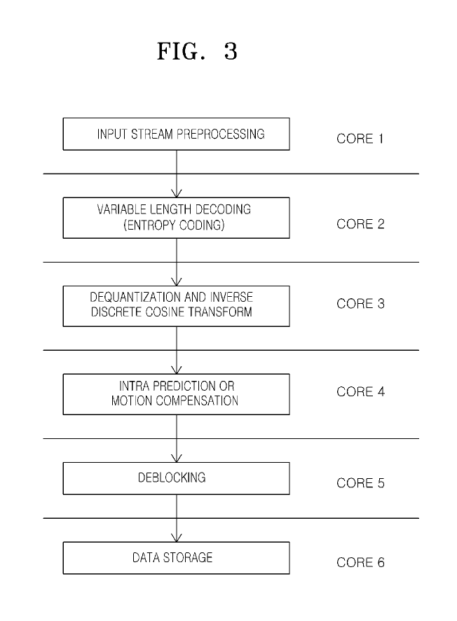

FIG. 1 is a diagram for describing a parallelization method by data division, FIG. 2 is a diagram for describing a parallelization method by functional division, and FIG. 3 is a diagram illustrating an example of a functional parallelization method for moving picture decoding.

A parallelizing processing method by a mufti-core processor is realized by data level and functional division as illustrated in FIGS. 1 and 2.

Referring to FIG. 1, parallelization by data division is a method for dividing information to be processed, that is, data and assigning the divided data so as to be performed different processors. This is a parallelization method that can be efficiently applied when data dependency is low.

Each core performs the same function while having different data. For example, core 1 has data 1 and data 4 and core 2 has data 2, and core 3 has data 3, data 5, and data 6. In the case of the multimedia moving picture decoding, the data may be divided in, for example, a frame, slice, macroblock, block unit.

In this case, when one sharing memory is used, degradation in performance occurs due to a memory bottleneck phenomenon and as the number of cores is increased, degradation in performance is increased due to communication overhead.

Referring to FIG. 2, parallelization by the functional division is a method that can be used when data dependency is high, which is a parallelization method for dividing applications into a function module and allowing different cores to perform the divided function modules. For example, the application may be sequentially divided into 6 function modules and the divided function modules 1 to 6 may be performed by each of the cores 1 to 6.

The parallelization method by the functional division is similar to a pipeline processing method and requires memory architecture for sharing information among neighboring cores. FIG. 3 illustrates an example of mapping of a function module in the case of the multimedia moving picture decoding.

Referring to FIG. 3, function module 1 performed by core 1 is an input stream preprocessing function, function module 2 performed by core 2 is a variable length decoding (entropy decoding) function, function module 3 performed by core 3 is a dequantization and inverse discrete cosine transform function, function module 4 performed by core 4 is an intra prediction or motion compensation function, function module 5 performed by core 5 is a deblocking function, and function module 6 performed by core 6 is a data storage function.

For the efficient parallelization of the multi-core processor, there is a need to support the parallelization method by both of the foregoing data division and functional division. To this end, memory communication architecture suitable for each parallelization is required.

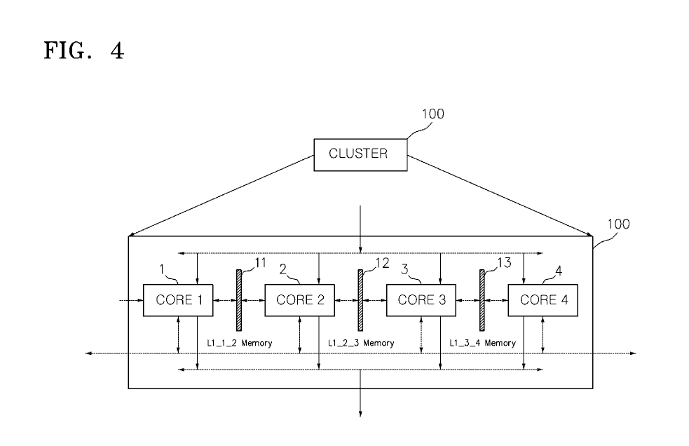

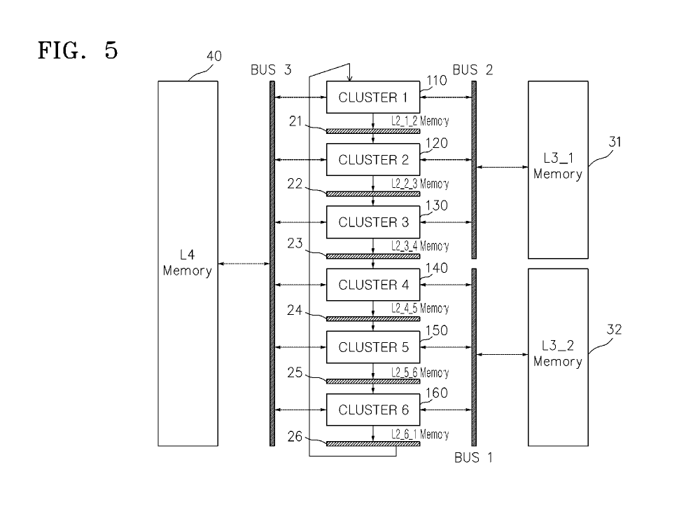

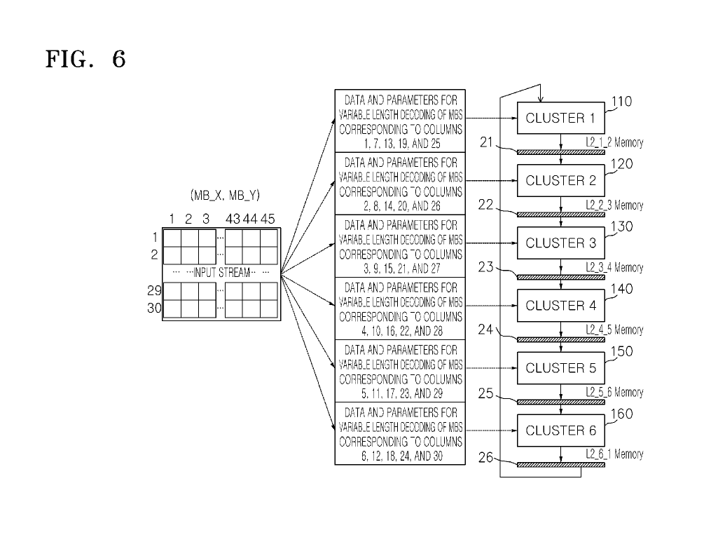

FIG. 4 is a diagram illustrating hierarchical communication architecture within any one cluster among multi-core processors having hierarchical communication architecture in accordance with an embodiment of the present invention, FIG. 5 is a mufti-core processor having hierarchical communication architecture in accordance with an embodiment of the present invention, and FIG. 6 is a diagram for describing a parallelization method of data level of multimedia moving picture decoding using an L2 memory of a mufti-core processor having hierarchical communication architecture in accordance with an embodiment of the present invention.

Although the hierarchical communication structure of four levels L1, L2, L3, and L4 will be described below, the scope of the present invention is not limited thereto. A method for clustering a level and a core of a memory can be flexibly applied according to applications while maintaining hierarchy.

Referring to FIG. 4, the L1 memories 11, 12, and 13, which are memories shared among cores 1, 2, 3, and 4 within a cluster 100, are used to implement the parallelization method by the functional division of applications. That is, it may be used as a purpose like a pipeline register in pipeline architecture.

A single cluster 100 includes the plurality cores 1, 2, 3, and 4 each mapped to the function modules performing predetermined functions and the L1 memories 11, 12, and 13 transmitting data processed by any core among respective cores to other neighboring cores.

For example, FIG. 4 illustrates a case of clustering four cores into one cluster under the assumption that the multimedia moving picture is decoded. The core 1 1 may be mapped to the dequantization and inverse discrete cosine transform function module, the core 2 2 may be mapped to the motion vector prediction function module, the core 3 3 may be mapped to the intra prediction function module and motion compensation and video reconstruction function module, and the core 4 4 may be mapped to the function module performing the deblocking function and the L1 memories 11, 12, and 13 perform a function of a single or double buffer transmitting data processed by each core to neighboring cores.

That is, the L1_{—}1_{—}2 memory 11 transmits data subjected to the dequantization and inverse discrete cosine transform by the core 1 1 between the core 1 1 and the core 2 2 to the core 2 2 to perform the motion vector prediction function. The L1_{—}2_{—}3 memory 12 transmits data subjected to the motion vector prediction by the core 2 2 between the core 2 2 and the core 3 3 to the core 3 3 to perform the intra prediction, motion compensation, and video reconstruction function. The L1_{—}3_{—}4 13 transmits data subjected to the intra prediction, motion compensation, and video reconstruction by the core 3 3 between the core 3 3 and the core 4 4 to the core 4 4 to perform the deblocking function.

Referring to FIG. 5, L2 memories 21, 22, 23, 24, 25, and 26, which are memories shared among clusters 110, 120, 130, 140, 150, and 160, is used to implement the parallelization method by the data division of applications.

That is, as illustrated in FIG. 4, the plurality of clusters 110, 120, 130, 140, 150, and 160 to which the parallelization method by the functional division using the plurality of cores and the L1 memory is applied share the L2 memories 21, 22, 23, 24, 25, and 26 disposed among the clusters 110, 120, 130, 140, 150, and 160. The cluster 1 110 and the cluster 2 120 share the L2_{—}1_{—}2 memory 21, the cluster 2 120 and the cluster 3 130 share L2_{—}2_{—}3 memory 22, the cluster 3 130 and the cluster 4 140 share the L2_{—}3_{—}4 memory 23, the cluster 4 140 and the cluster 5 150 share the L2_{—}4_{—}5 memory 24, the cluster 5 150 and the cluster 6 160 share the L2_{—}5_{—}6 memory 25, and the cluster 6 160 and the cluster 1 110 share the L2_{—}6_{—}1 memory 26.

FIG. 6 illustrates an example that 45×30 macroblocks of 720×480 size images are divided into a column unit data by using the L2 memories 21, 22, 23, 24, 25, and 26 and then, each cluster decodes the corresponding columns. Here, it is assumed that the size of the macroblock is 16×16.

Data and parameters for variable length decoding of macroblocks corresponding to 6n+1-th (here, n is an integer of 0 or more) column (columns 1, 7, 13, 19, and 25) are assigned to the cluster 1 110, data and parameters for variable length decoding of macroblocks corresponding to 6n+2-th column (columns 2, 8, 14, 20, and 26) are assigned to the cluster 2 120, data and parameters for variable length decoding of macroblocks corresponding to 6n+3-th column (columns 3, 9, 15, 21, and 27) are assigned to the cluster 3 130, data and parameters for variable length decoding of macroblocks corresponding to 6n+4-th column (columns 4, 10, 16, 22, and 28) are assigned to the cluster 4 140, data and parameters for variable length decoding of macroblocks corresponding to 6n+5-th column (columns 5, 11, 17, 23, and 29) are assigned to the cluster 5 150, and data and parameters for variable length decoding of macroblocks corresponding to 6n+6-th column (columns 6, 12, 18, 24, and 30) are assigned to the cluster 6 160, which are in turn subjected to parallel processing.

Referring again to FIG. 5, the L3 memories 31 and 32, which are memories shared within a super cluster configured of three clusters 110, 120, 130 or 140, 150, and 160, is used for communication among the cores within the super cluster.

The first super cluster is configured of clusters 1 to 3 110, 120, and 130 and shares the L3_{—}1 memory 31 via a first bus BUS 1. The second super cluster is configured of clusters 4 to 6 140, 150, and 160 and shares the L3_{—}1 memory 32 via a second bus BUS 2.

The L4 memory 40, which is a memory that can be shared by the core included in all the clusters, is used as a purpose for storing data that need to be shared by all the cores. For example, the L4 memory 40 is used as a purpose for storing frame data that need to be shared by all the cores in the case of the moving picture decoding.

The clusters 1 to 6 110, 120, 130, 140, 150, and 160 share the L4 memory 40 via a third bus BUS 3.

Although a hierarchical memory access is already described as being implemented by the memory buses BUS 1 to 3, the scope of the present invention is not limited thereto and therefore, the present invention may also be implemented by a direct memory access (DMA).

In addition, in the exemplary embodiment of the present invention, the number of cores included in one cluster, a total number of clusters, the number of clusters included in the super cluster, and the like, may be changed according to applications.

In the exemplary embodiment of the present invention, a basic principle of the memory access performs communication primarily using a low level memory and performs hierarchical communication while increasing a level by one step, if necessary.

According to the mufti-core processor having the hierarchical communication structure as described above, it is possible to reduce the communication overhead among respective cores and improve the performance of applications by supporting the data level and functional parallelization.

In addition, the mufti-core processor has the hierarchical communication structure and therefore, even which the number of cores is increased, has the applicable extendibility and the high generality in that the parallelization for various applications can be implemented.

In accordance with the embodiments of the present invention, it is possible to improve the performance of the applications by reducing the communication overhead among respective cores and supporting the data and functional parallelization.

Further, the embodiment of the present invention has the hierarchical structure, thereby achieving the applicable extendibility, the high generality due to parallelization implementation of various applications, and the efficient communication among the specific processors.

Although the embodiments of the present invention have been described in detail, they are only examples. It will be appreciated by those skilled in the art that various modifications and equivalent other embodiments are possible from the present invention. Accordingly, the actual technical protection scope of the present invention must be determined by the spirit of the appended claims.

What is claimed is:

1. A mufti-core processor, comprising:
clusters in which cores are clustered;
a lowest level memory shared among the cores included in the clusters;
a middle level memory shared among the clusters; and
a highest level memory shared by all the clusters.

2. The mufti-core processor of claim 1, wherein the middle level memory includes:
a middle and low level memory which is shared by the cluster and its other neighboring clusters; and
a middle and high level memory shared in a super cluster in which the clusters are clustered.

3. The mufti-core processor of claim 1, wherein the lowest level memory is used to implement a parallelization method by functional division of applications.

4. The mufti-core processor of claim 3, wherein the lowest level memory performs a single or double buffer function transmitting data processed by the cores to neighboring cores.

5. The mufti-core processor of claim 1, wherein the middle level memory is used to implement a parallelization method by data division of applications.

6. The mufti-core processor of claim 1, wherein the highest level memory is used to store data shared for the cores to perform applications.

7. The mufti-core processor of claim 1, wherein a memory access is performed in an order of the lowest level memory, the middle level memory, and the highest level memory at the time of performing communication among the cores.

8. The mufti-core processor of claim 7, wherein the memory access is performed through a memory bus or a direct memory access (DMA).
